(19) United States
(12) Patent Application Publication
(10) Pub. No.: US 2006/0208498 A1
(43) Pub. Date: Sep. 21, 2006

(54) Storage and display tray assembly

(76) Inventors: Justin M. Smyers, San Luis Obispo, CA (US); Donald L. Bell, Northridge, CA (US); Ryan C. Meers, Los Angeles, CA (US)

Correspondence Address: CARLSON, GASKEY & OLDS, P.C., 400 WEST MAPLE ROAD, SUITE 350, BIRMINGHAM, MI, 48009, US

(21) Appl. No.: 11/368,350

(22) Filed: Mar. 3, 2006

Related U.S. Application Data
(60) Provisional application No. 60/658,838, filed on Mar. 4, 2005.
(60) Provisional application No. 60/735,375, filed on Nov. 12, 2005.

(51) Int. Cl. E05C 1/04

(52) U.S. Cl. 292/152

(57) ABSTRACT

A tray assembly includes a lower tray slidably connected to a slider. The slider includes a first interlocking portion and the lower tray includes a second interlocking portion. The interlocking portions slidably fit together to allow the slider to slide relative to the lower tray. When the tray assembly is partially full of containers the slider is pulled and slid relative to the lower tray. The end wall of the slider slides the containers along the base toward the end of the lower tray. The slider would then be slid back to its neutral position leaving the containers at the front of the tray assembly. In this manner all the containers can be moved to the front of the tray assembly.

### REFERENCE TO RELATED APLICATIONS

This application claims priority to U.S. Provisional Application Ser. No. 60/658,838, filed Mar. 4, 2005 and U.S. Provisional Application Ser. No. 60/735375, filed Nov. 12, 2005.

### BACKGROUND OF THE INVENTION

This invention relates to a tray for storing and displaying containers.

Small food or beverage containers are currently packaged and shipped in boxes from a manufacturing site to individual sale locations. At the store the containers are removed from the boxes and arranged on refrigerator shelves for display to customers. While shopping customers usually select one or more of the containers positioned at the front of the shelf. As the shelved containers are removed it becomes more difficult for customers to see the products. In order to provide an improved shopping experience for customers store workers periodically move the remaining containers to the front of the shelf to make them more visible and accessible.

Individually unloading containers onto the stores shelves and periodically shifting all of the rows of containers forward is time-consuming.

Therefore, an improved arrangement for shipping, storing and displaying containers is desirable.

### SUMMARY OF THE INVENTION

A tray assembly according to the present invention includes a lower tray slidably connected to a slider such that container located on the tray may be easily moved to the front end of the container.

The slider includes end walls and side walls with handles formed in the end walls. The lower tray includes a base surrounded by end and side walls having container-receiving pockets formed within the base. The lower tray includes slots extending substantially the entire length and a protrusion extends from the slider in a corresponding position to the slots on the lower tray. The slots in the lower tray have at least one portion for receiving the protrusion of the slider slidably interlocking the slider with the lower tray.

When the tray assembly is partially full the slider is pulled and slid relative to the lower tray. The end wall of the slider slides the containers along the base toward the end of the lower tray. The slider would then be slid back to its neutral position leaving the containers at the front of the tray assembly. In this manner all the containers can be moved to the front of a store or refrigerator shelf, to improve the accessibility and visibility of the containers for customers. The slider can slide in either direction such that the tray assembly can be placed on the shelf in either orientation.

The upper ends of the containers received in pockets formed in the lower surface of the base to improve the stability of stacked, loaded tray assemblies. The base and portions of the end walls of the lower tray nest within a crate, while the end walls and side walls of the slider are supported on the walls of the crate to facilitate transportation of the tray assemblies along with other goods in the crate.

Accordingly, the trays of this invention provide an improved arrangement for shipping and displaying containers.

These and other features of the present invention can be best understood from the following specification and drawings, the following of which is a brief description.

### BRIEF DESCRIPTION OF THE DRAWINGS

FIG. 1 is a perspective view of a tray assembly according to a first embodiment of the present invention.

FIG. 2 is an exploded view of the first example tray assembly of FIG. 1.

FIG. 3 is an enlarged view of one corner of the tray assembly of FIG. 1.

FIG. 4 is a perspective view of the first example tray assembly filled with a plurality of containers.

FIG. 5 is a perspective view of the first example tray assembly with some of containers removed and the slider is slid relative to the lower tray.

FIG. 6 is a perspective view of the first example tray assembly with some of containers removed and the slider is slid relative to the lower tray in the direction opposite that shown in FIG. 5.

FIG. 7 is a bottom perspective view of the loaded tray assembly stacked on a similar loaded tray assembly.

FIG. 8 is a perspective view of a stack of a loaded example tray assembly stacked onto a crate.

FIG. 9 is an exploded view of a stack of loaded example tray assembly and a crate.

FIG. 10 is a sectional view through the side wall of an alternate slider for the example tray assembly of FIGS. 1-9.

FIG. 11 is an exploded view of an alternate tray and slider interface with the slider of FIG. 10.

FIG. 12 is a perspective view of the assembled tray and slider interface of FIG. 11.

FIG. 13 is a side view of an alternate assembled tray and slider interface of FIG. 11.

FIG. 14 is a perspective view of a tray assembly according to a second embodiment of the present invention.

FIG. 15 is a perspective view of the second example tray assembly filled with a plurality of containers.

FIG. 16 is a perspective view of the second example tray assembly with some of containers removed and the slider slid relative to the lower tray.

FIG. 17 is a perspective view of the second example tray assembly with some of containers removed and the slider slid relative to the lower tray in the direction opposite that shown in FIG. 16.

FIG. 18 illustrates a plurality of loaded tray assemblies according to the second embodiment stacked upon one another and on a crate.

FIG. 19 is a perspective view of a third example tray assembly where the slider is slid relative to the lower tray.

FIG. 20 is a perspective view of the third example tray assembly.

FIG. 21 is a perspective view of the third example tray assembly where the slider is slid relative to the lower tray in the direction opposite that shown in FIG. 19.

FIG. 22 illustrates a tray assembly according to a fourth embodiment of the present invention.

FIG. 23 is a perspective view of the fourth example tray assembly where the slider is slid relative to the lower tray.

FIG. 24A illustrates a section taken through the side wall of the slider of the fourth example tray assembly.

FIG. 24B is an enlarged view of Area B of FIG. 24A.

FIG. 25 is a perspective view of the fourth example tray assembly loaded with a plurality of containers.

FIG. 26 is a side view of the fourth example tray assembly loaded with a plurality of containers.

FIG. 27 is a perspective view of the fourth example tray assembly where the slider is slid relative to the lower tray.

FIG. 28 illustrates two empty fourth example tray assemblies stacked on one another.

FIG. 29A illustrates a side view of the stacked fourth example tray assemblies of FIG. 28.

FIG. 29B is an enlarged view of Area B of FIG. 29A.

FIG. 30 illustrates the fourth example tray assemblies of FIG. 28 cross-stacked.

FIG. 31 is an enlarged interior view of a portion of the cross-stacked fourth example tray assemblies of FIG. 30.

### DETAILED DESCRIPTION OF PREFERRED EMBODIMENTS

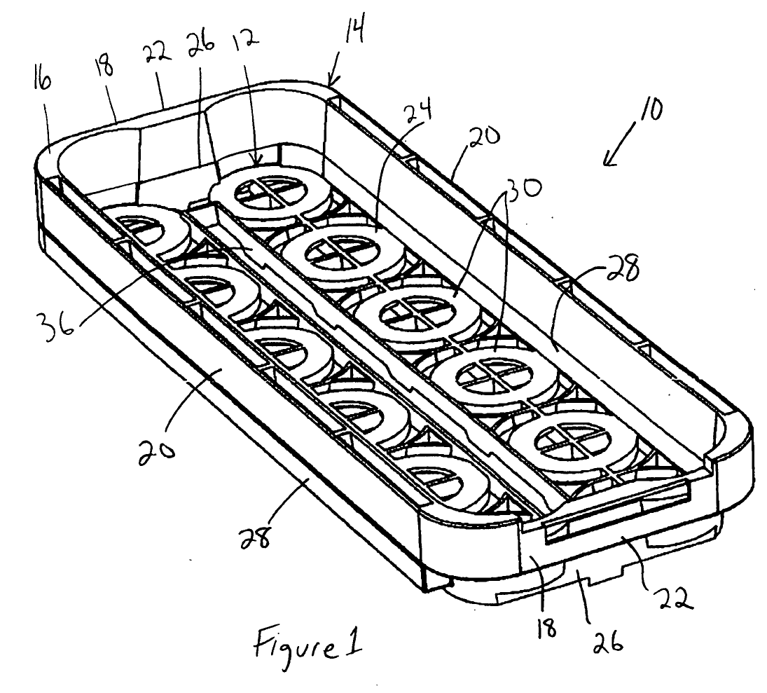

A tray assembly 10 according to a first embodiment of the present invention is shown in FIG. 1. The tray assembly 10 includes a lower tray 12 which is slidably connected to a slider 14. The slider 14 includes a peripheral wall 16 having end walls 18 and side walls 20. Handles 22 are formed in the end walls 18.

The lower tray 12 includes a floor or base 24 surrounded by a short peripheral wall including end walls 26 and side walls 28. Container-receiving pockets 30 are formed in the base 24. A ventilation opening 36 extends between the container-receiving pockets 30 across substantially the entire length of the base 24.

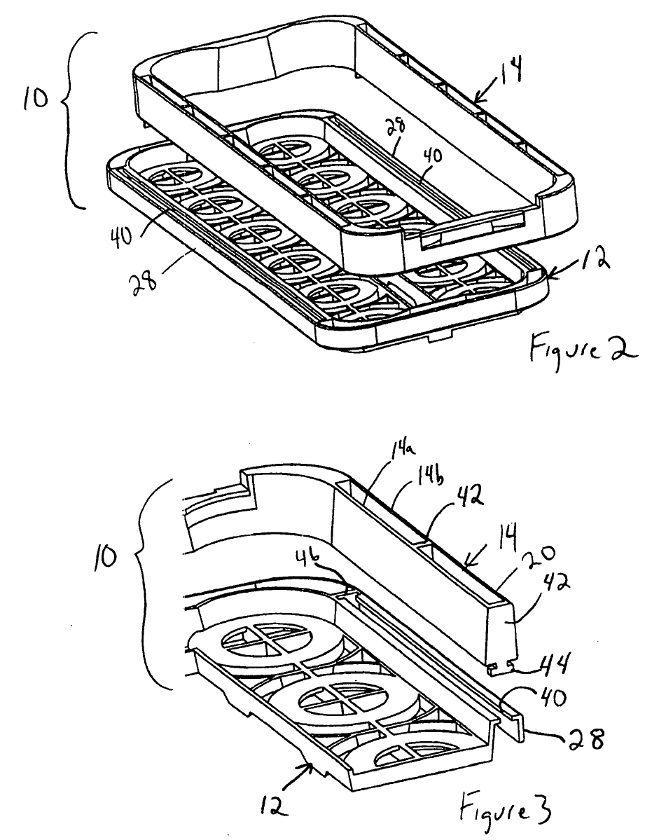

FIG. 2 is an exploded view of the tray assembly 10 of FIG. 1. The side walls 28 of the lower tray 12 include slots 40 extending substantially the entire length of the side walls 28.

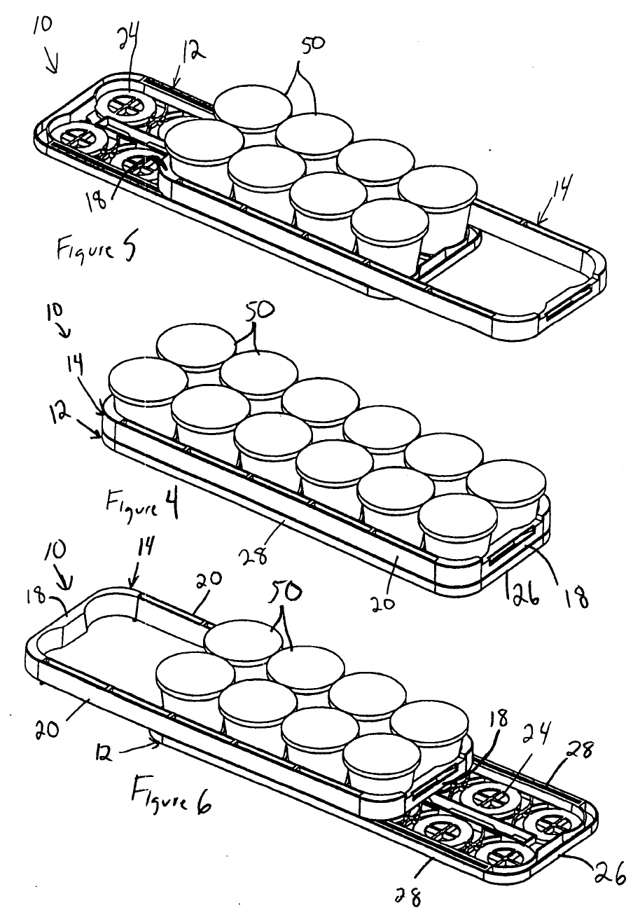

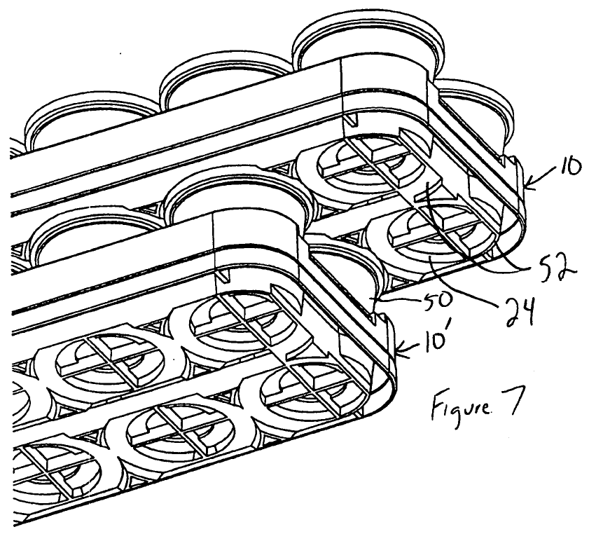

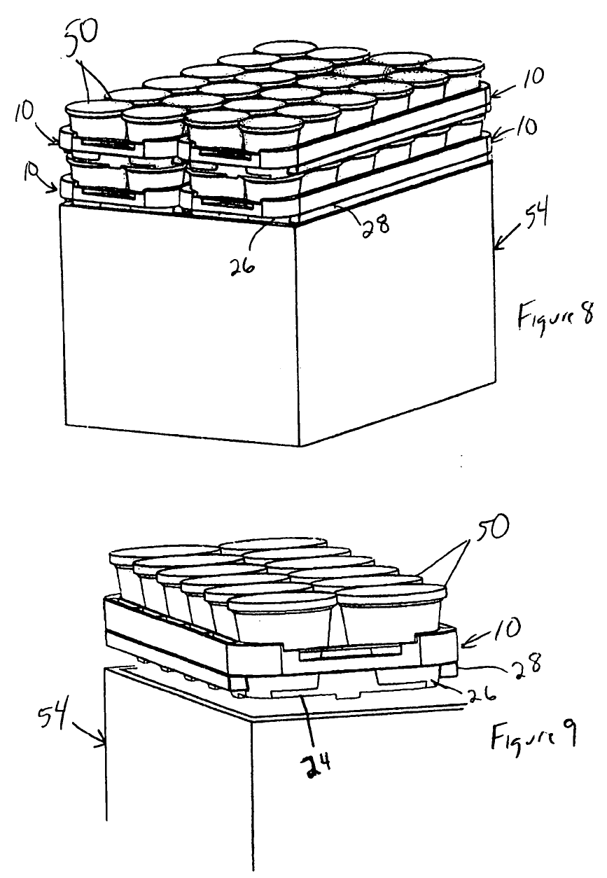

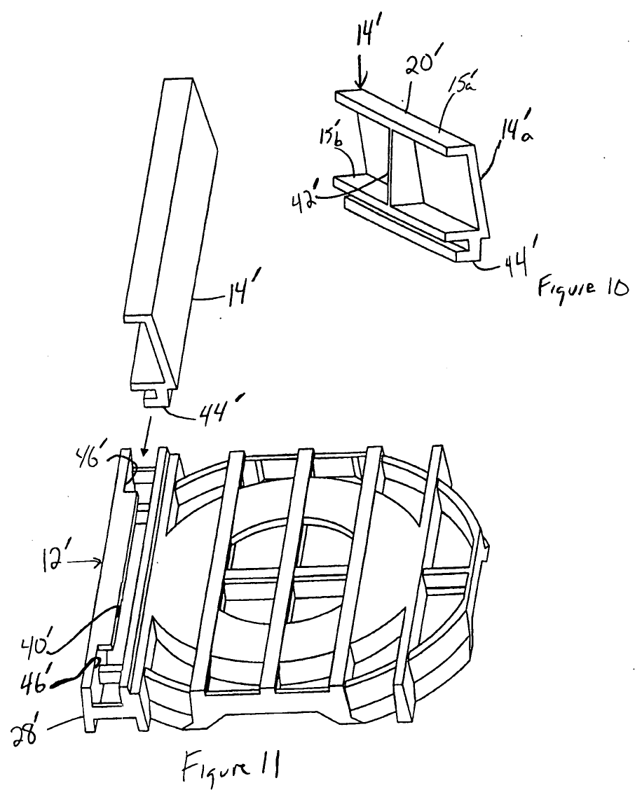

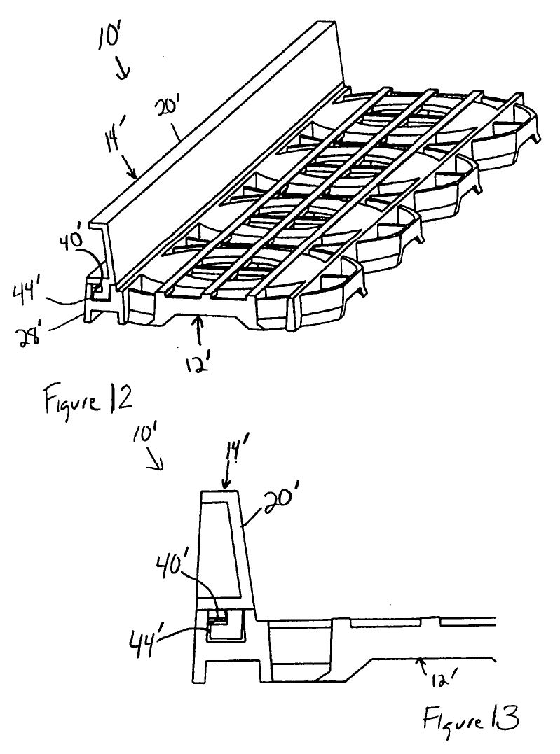

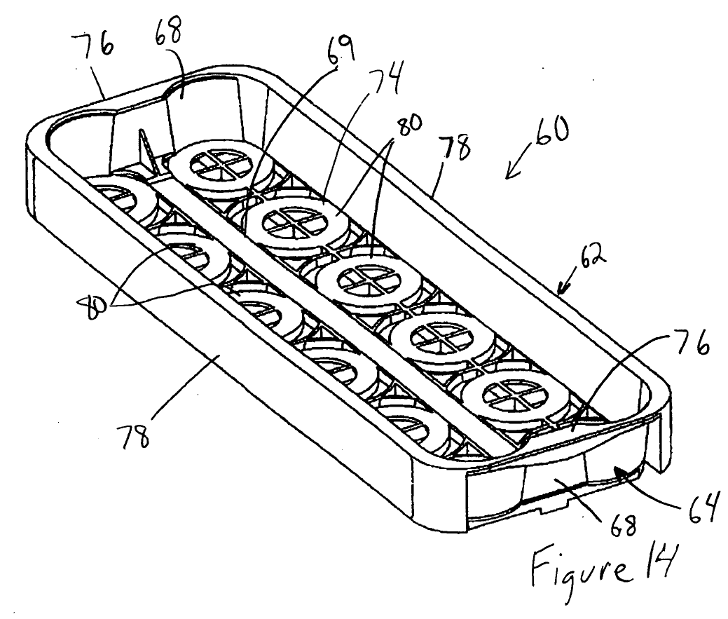

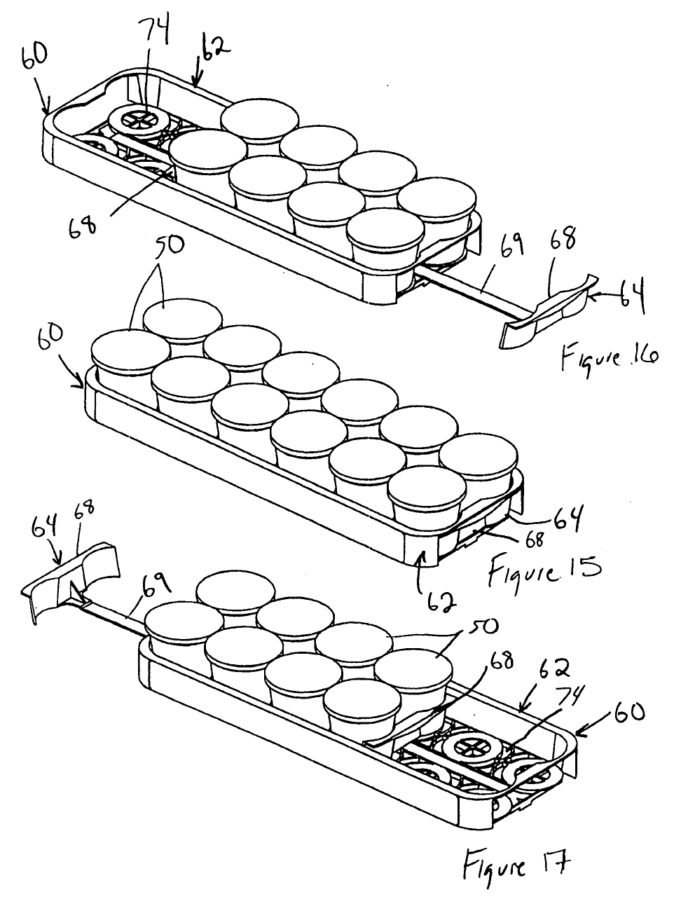

FIG. 3 is an enlarged view of one corner of the tray assembly 10, partially broken away. The side wall 20 of the slider 14 includes an inner wall 14a spaced from an outer wall 14b. Ribs 42 extend perpendicularly between the inner wall 14a and the outer wall 14b. At least one of the ribs 42 protrudes downwardly from the inner wall 14a and outer wall 14b to form an interlocking member 44, which in the embodiment shown is an inverted T-shaped interlocking member 44. The slot 40 in the side wall 28 of the lower tray 12 has at least one widened portion 46 for receiving the interlocking member 44 of the slider 14. For assembly, the interlocking member 44 of the slider 14 is inserted into the widened portion 46 of the slot 40 in the lower tray 12. The slider 14 is thereby slidably interlocked with the lower tray 12, such that the slider 14 can slide among the positions shown in FIGS. 4-6.

In FIG. 4, a plurality of containers 50 fill the tray assembly 10. The containers 50 and tray assembly 10 may be shipped to the store and set on a shelf in a refrigerator for display and purchase. The end walls 18 of the slider 14 are vertically aligned with the end walls 26 of the lower tray 12 to maximize the storage space available in the tray assembly 10.

In FIG. 5, some of the containers 50 have been removed (e.g. purchased) so that the tray assembly 10 is not full of the containers 50. To bring all the containers 50 to one end (i.e. the “front”) of the tray assembly 10, the slider 14 is pulled and slid relative to the lower tray 12, while the slider 14 remains interlocked with the lower tray 12. The end wall 18 of the slider 14 slides the containers 50 along the base 24 toward the end of the lower tray 12 as shown. In this manner, a store clerk can quickly and easily move all the containers 50 to the front of the store shelf or refrigerator shelf, to improve the accessibility and visibility of the containers for customers. The slider 14 would then be slid back to its neutral position (FIG. 4), leaving the containers 50 at the front of the tray assembly 10.

As shown in FIG. 6, the slider 14 can slide in the direction opposite that shown in FIG. 5. As a result, the tray assembly 10 can be placed on the shelf in either orientation without concern for which end is the “front.”

FIG. 7 is a bottom perspective view of the loaded tray assembly 10 stacked on a similar loaded tray assembly 10′. The upper ends of the containers 50 in the lower tray assembly 10′ are received in pockets 52 formed in the lower surface of the base 24 of the upper tray assembly 10. This improves the stability of stacked, loaded tray assemblies 10, 10′.

FIGS. 8 and 9 show how a plurality of tray assemblies 10, each loaded with containers 50, can be stacked onto a crate 54, such as a milk crate. The base 24 and portions of the end walls 26 of the lower tray 12 nest within the crate 54, while the end walls 18 and side walls 20 of the slider 14 are supported on the walls of the crate 54. This facilitates transportation of the tray assemblies 10 along with other goods in the crate 54.

FIGS. 10-13 illustrate an alternate connection between the slider 14 and the lower tray 12. To the extent not otherwise described or illustrated, the slider 14 and lower tray 12 are the same as in FIGS. 1-9. FIG. 10 is a sectional view through an alternate side wall 20′ of the alternate slider 14′. The side wall 20′ includes an inner wall 14a′ having an upper lip 15a′ and a lower lip 15b′ connected by perpendicular ribs 42′. A plurality of L-shaped interlocking members 44′ protrude downwardly from the lower lip 15b′.

Referring to FIG. 11, the alternate side wall 28′ of the lower tray 12′ includes a slot 40′ having widened portions 46′ for receiving the interlocking members 44′ of the side wall 20′ of the slider 14′. As shown in FIGS. 12 and 13, the interlocking member 44′ interlocks with the slot 40′ to slideably connect the slide 14′ to the lower tray 12′ in the alternate tray assembly 10′.

A tray assembly 60 according to a second embodiment of the present invention is shown in FIG. 14. The tray assembly 60 includes a tray 62 and a slider 64. The slider 64 includes end walls 68 connected by a narrow rail 69. The rail 69 of the slider 64 is slidably supported on a floor or base 74 of the tray 62 between container-receiving pockets 80 in the base 74. The tray 62 includes end rails 76 connecting side walls 78 at each end. The tray 62 is open below the end rails 76. The end walls 68 of the slider 14 are received below the end rails 76 when the slider is in the neutral position as shown in FIG. 18. Handles 72 are formed in each end wall 68 of the slider 14.

The slider 64 is preferably slidably interlocked with the tray 62, for example, by an interlocking member (not shown) on the rail 69 interlocking with a slot (not shown) in the base 74 (similar to the slidable interlocking connection in the first embodiment and the alternate slidable interlocking connection). There may also be tabs (not shown) that are canted to permit the slider 64 to be assembled into the tray 62 through the end openings, but prevent the slider 64 from accidentally sliding out back through the end openings in the tray 62.

In FIG. 15, a plurality of containers 50 fill the tray assembly 60. The containers 50 and tray assembly 60 may be shipped to the store and set on a shelf in a refrigerator for display and purchase.

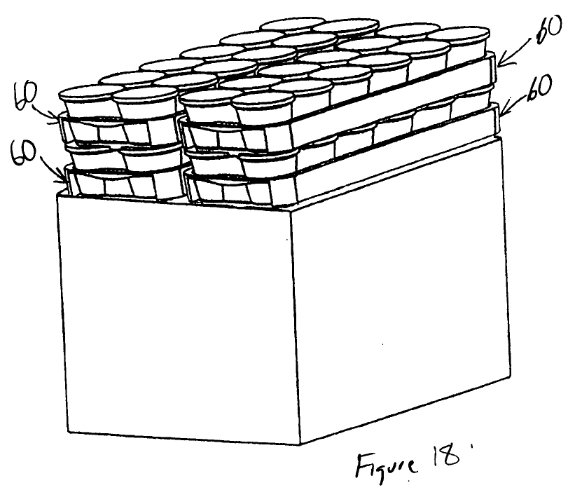

In FIG. 16, some of the containers 50 have been removed (e.g. purchased) so that the tray assembly 60 is not full of the containers 50. To bring all the containers 50 to one end (i.e. the “front”) of the tray assembly 10, the slider 64 is pulled and slid relative to the lower tray 62. The end wall 68 of the slider 64 slides the containers 50 along the base 74 toward the end of the lower tray 62 as shown. The slider 64 would then be slid back to its neutral position (FIG. 15), leaving the containers 50 at the front of the tray assembly 60.

As shown in FIG. 17, the slider 64 can slide in the direction opposite that shown in FIG. 16. As a result, the tray assembly 60 can be placed on the shelf in either orientation without concern for which end is the “front.”

FIG. 18 illustrates a plurality of loaded tray assemblies 60 stacked upon one another and on a crate 54, such as a milk crate. The base 74 of the tray 62 nests within the crate 54, while the side walls 78 of the tray 62 are supported on the walls of the crate 54. This facilitates transportation of the tray assemblies 60 along with other goods in the crate 54.

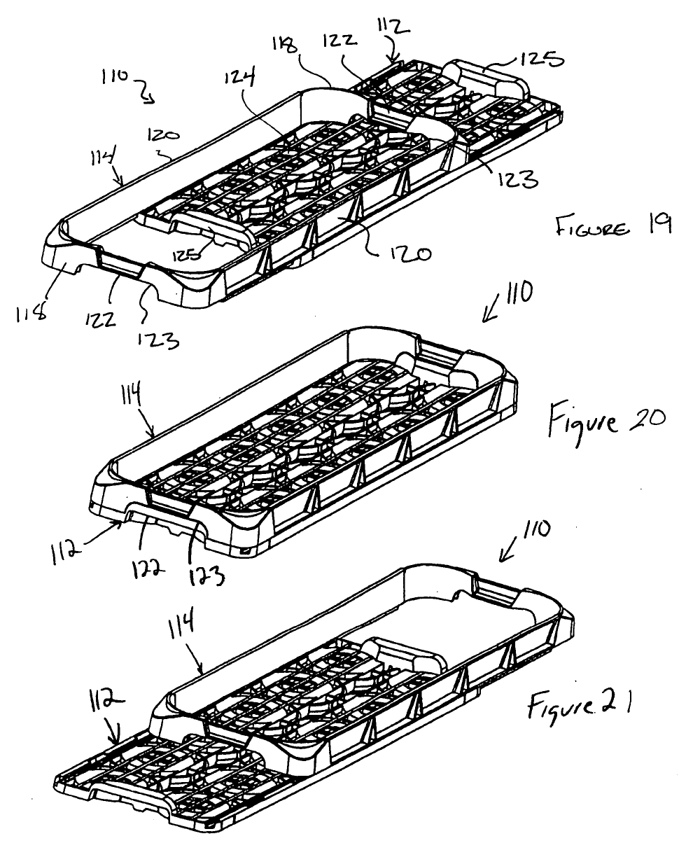

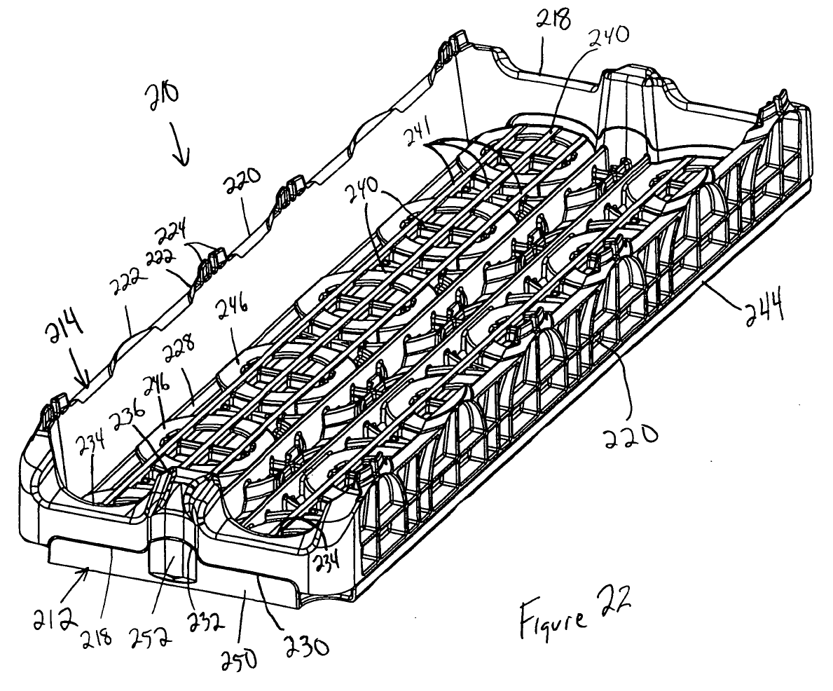

FIGS. 19-21 illustrate a tray assembly 110 according to a third embodiment of the present invention. Referring to FIG. 19, the tray assembly 110 includes a tray 112 and a slider 114 slidably mounted on the tray 112. The slider 114 includes a peripheral wall 116 having end walls 118 and side walls 120. Handles 122 are formed in the end walls 118, with openings 122 defined below the handles 122 through the end walls 118. The side walls 120 are slidably connected to the tray 112 in a manner similar to that shown in FIGS. 10-13, although the slidable connection of FIGS. 1-9 could also be used. The tray 112 also includes handles 125 at opposite ends. The handles 125 on the tray 112 are received in the openings 122 under the handles 122 in the end walls 118 of the slider 114 when the slider 114 is in the neutral position, as shown in FIG. 20.

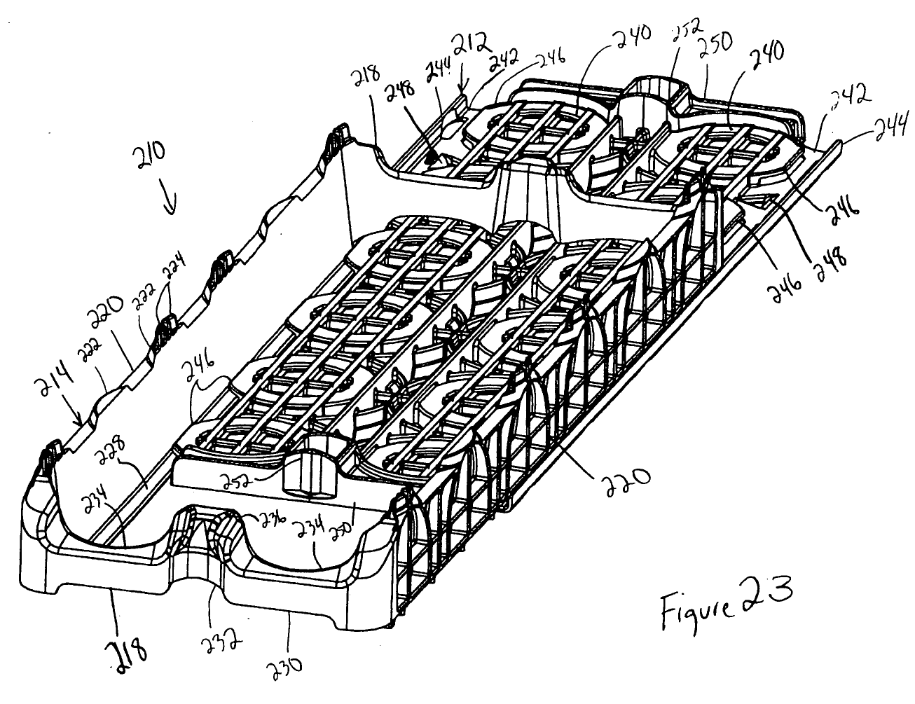

The tray assembly 110 of FIGS. 19-21 operates in a manner generally similar to the first embodiment. The slider 114 is slidable relative to the tray 112 from the neutral position of FIG. 20 toward one direction (FIG. 19) or toward the opposite direction (FIG. 21) relative to the tray 112. In this embodiment, the handles 122 on the tray 112 provide a stable connection to the load-bearing base 124 of the tray 112.

A tray assembly 210 according to a fourth embodiment of the present invention is shown in FIGS. 22-31. Referring to FIG. 22, the tray assembly 210 includes a tray 212 slidably connected to a slider 214. The slider 214 includes a peripheral wall 216 having end walls 218 and side walls 220. The upper edge of each side wall 220 includes a plurality of spaced-apart upward protrusions 222, some of which include a pair of spaced-apart tabs 224 projecting further upward. A rail 228 projects inwardly from the lower edge of each of the side walls 220.

Each of the end walls 218 of the slider 214 includes a recess 230 defined therebelow, including a higher central portion 232. The upper edge of each of the end walls 218 defines a pair of windows 234 on either side of a center column 236.

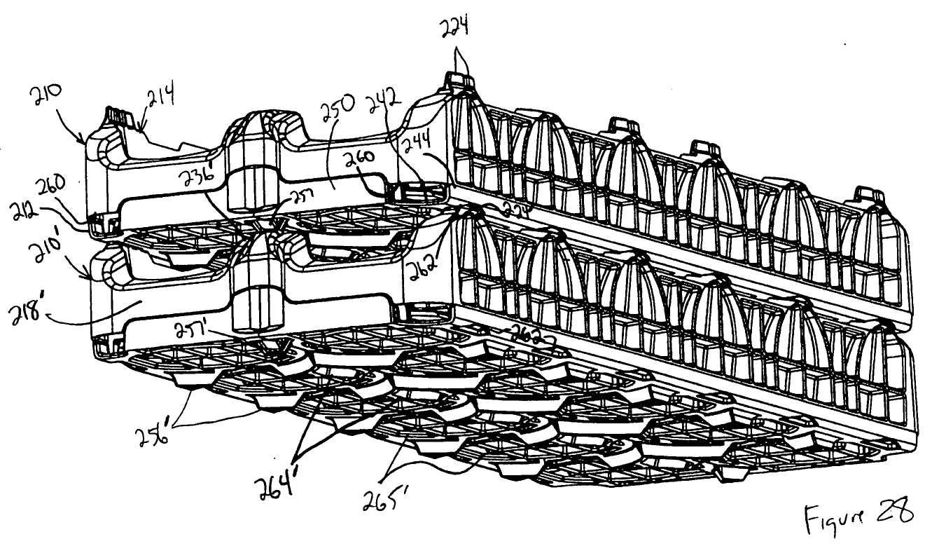

The tray 212 defines a plurality of container-supporting areas 240 having a plurality of support rails 241 extending thereacross from one end wall 218 to the other. Each of the container-supporting areas 240 includes an annular, planar support 246 partially interlocked over the rail 228 of the slider 214 such that the tray 212 and slider 214 are slidable relative to one another as shown in FIGS. 27 and 28.

The tray 212 further includes upstanding end walls 250 each having a taller center portion 252. In the neutral position shown in FIG. 22, the center portion 252 of each end wall 250 of the tray 212 is received in the central portion 232 of the recess 230 under the end wall 218 of the slider 214. The center portion 252 abuts the end wall 218 to provide support.

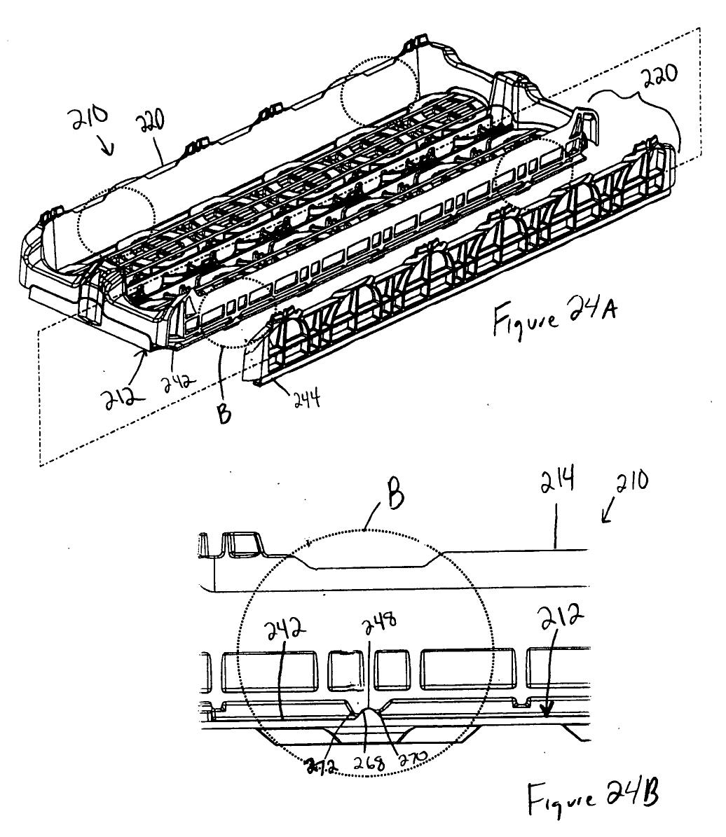

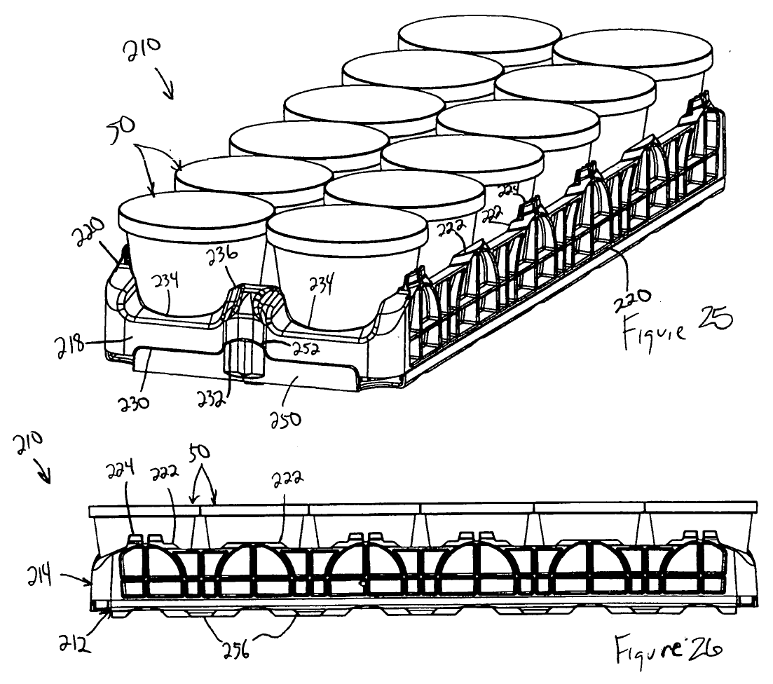

Referring to FIG. 23, the tray 212 includes an elongated upstanding side rail 244 along each side edge, spaced outwardly from the annular, planar supports 246 to define a track 242 in which the rails 228 of the slide 214 are slidably received. The annular, planar supports 246 partially interlock over the rail 228 of the slider 214 to slidably secure the slider 214 to the tray 212. The track 242 includes a plurality of upward protrusions 248 that engage the slider 214 in a manner shown in FIGS. 24A and 24B.

FIG. 24A illustrates a section taken through the side wall 220 of the slider 214. FIG. 24B is an enlarged view of Area B of FIG. 24A. When the slider 214 is in the neutral (center) position, the upward protrusion 248 engages a detent 268 defined between an inner downward protrusion 270 and an outer downward protrusion 272. This assists in retaining the slider 214 in the neutral position relative to the tray 212. The outer downward protrusions 272 (i.e. the outer downward protrusions 272 closer to the closer end wall 218) extend further downward than the inner downward protrusions 270. This provides additional resistance to 1) moving the slider 214 out of the neutral position (shown in FIG. 24A and 24B) and to 2) moving the slider 214 out of the tray 212 past the point where the outer downward protrusion 272 engages the upward protrusion 248 at the opposite end of the tray 212 (i.e. right before the slider 214 separates from the tray 212. This helps prevent the user from inadvertently pulling the slider 214.completely out of the tray 212.

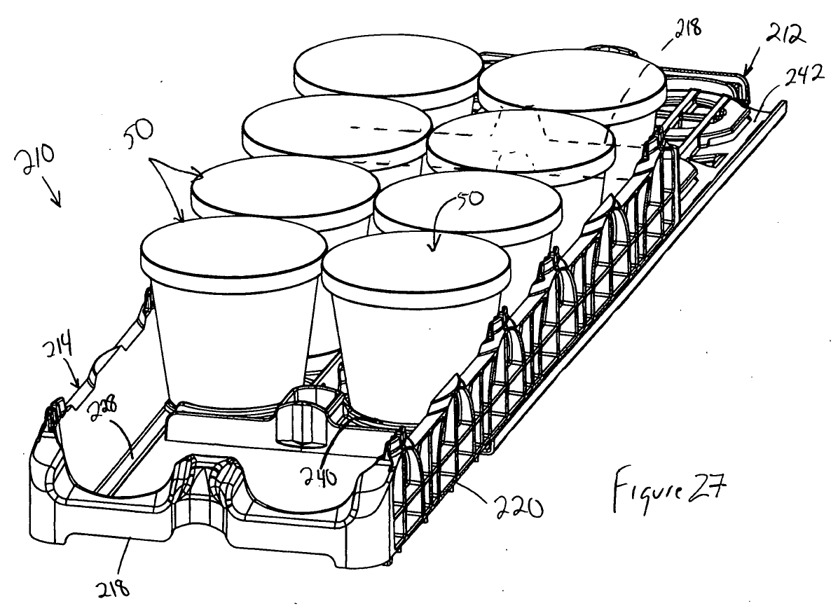

FIG. 25 is a perspective view of the tray assembly 210 with the slider 214 in the neutral position and loaded with a plurality of containers 50. The upward protrusions 222 on the upper edges of the side walls 220 are each aligned with one of the containers 50 (FIG. 26). Containers 50 adjacent the end walls 218 are more visible through the windows 234 formed in the upper edges of the end walls 218.

Referring to FIG. 27, when some of the containers 50 have been removed from the front of the tray assembly 210, the slider 214 can be pulled forward relative to the tray 212. The rails 228 of the slider 214 slide in the tracks 242 of the tray 212 and the far end wall 218 (shown in phantom) pushes the containers 50 toward the front of the tray assembly 210. The slider 214 is then returned to the neutral position.

When empty, the tray assembly 210 can be stacked on a similar tray assembly 210′ as shown in FIG. 28. To increase stability, the tabs 224′ of the lower tray assembly 210′ are received in aligned openings 262 through the track 242 portion of the tray 212 of the upper tray assembly 210. To provide further support to the upper tray.212, the center column 236′ of the end wall 218′ of the lower tray assembly 210′ contacts and supports a foot 257 extending downwardly from the tray 212 of the upper tray assembly 210. As can be seen on the lower tray assembly 210′ in FIG. 28, the bottom of the tray 212′ includes a plurality of triangular peripheral feet 256′ and a plurality of diamond-shaped central feet 265′. Between the peripheral feet 256′ and the central feet 265′ are defined a plurality of container lid-receiving recesses 265′, which are complementary to the lids of the containers 50 in FIG. 27 to further increase stability when stacking loaded tray assemblies 210, 210′.

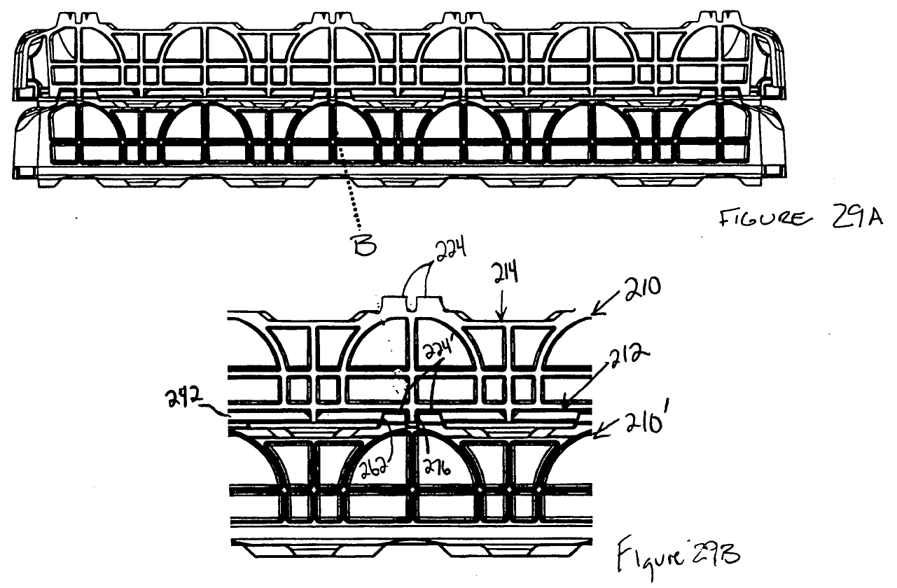

FIGS. 29A and 29B illustrate an enlarged view of a portion of the stacked tray assemblies 210, 210′ of FIG. 28. As shown, the tabs 224′ of the lower tray assembly 210′ are received in the openings 262 through the track 242 of the upper tray assembly 210 and receive between them a downwardly-extending rib 276. This increases the stability of the stacked tray assemblies 210, 210′.

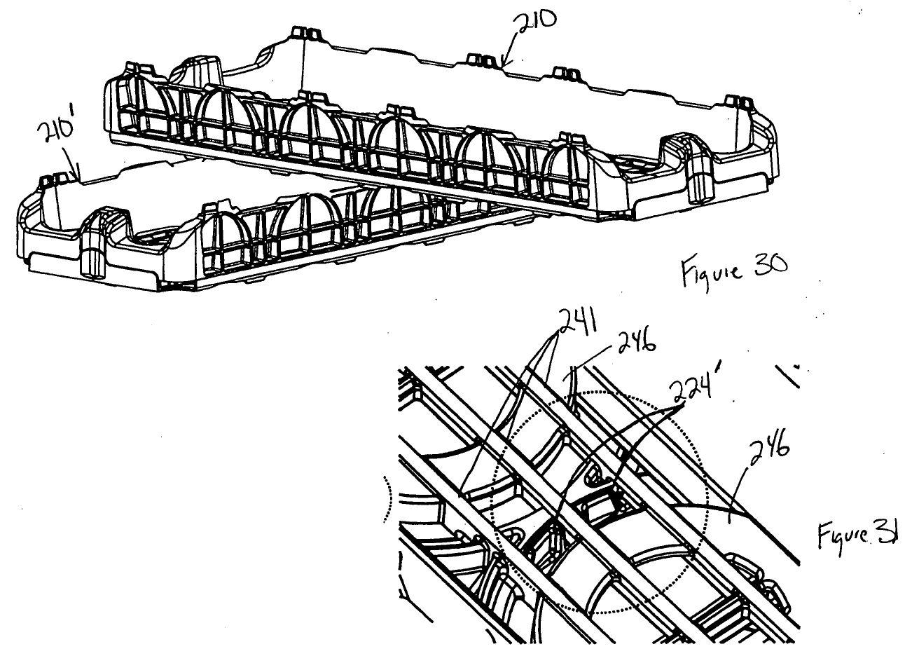

The tray assemblies 210, 210′ can also be cross-stacked as shown in FIG. 30 (although only one lower tray assembly 210′ is shown for clarity, the upper tray assembly 210 would normally be cross stacked on two side-by-side lower tray assemblies 210′). FIG. 31 is an enlarged interior view of a portion of the tray 212 of the upper tray assembly 210, showing a portion of the support rails 241 between adjacent annular, planar supports 246. As shown, in the cross-stacked arrangement, the two tabs 224′ interlock between the three support rails 241 to prevent relative lateral movement between the tray assemblies 210, 210′.

Although other materials and techniques could be used, it is contemplated that the trays 12, 62, 112, 212 and sliders 14, 64, 114, 214 would be injection molded of plastic, such as polypropylene.

The invention has been described in an illustrative manner, and it is to be understood that the terminology that has been used is intended to be in the nature of words of description rather than of limitation. Obviously, many modifications and variations of the present invention are possible in light of the above teachings. It is, therefore, to be understood that within the scope of the appended claims the invention may be practiced otherwise than as specifically described.

What is claimed is:

1. A tray assembly comprising:
a tray having a plurality of container support areas; and
a slider having a pair of side walls slidably mounted to the tray and an end wall slidable across at least a portion of the container support areas of the tray.

2. The tray assembly of clam 1, wherein the tray has a slot formed within each of a pair of side walls of the tray and wherein a protrusion extends from the each of the pair of side walls of the slider to interfit with the slot.

3. The tray assembly of claim 2, wherein the protrusion comprises a T-shape.

4. The tray assembly of claim 2, wherein the protrusion comprises a L-shape.

5. The tray assembly of claim 2, wherein the side walls of the slider include an inner side wall and an outer side wall and a rib extends between the inner side wall and the outer side wall, and the protrusion extends from the rib.

6. The tray assembly of claim 2, wherein the lower tray comprises a widened portion in the slot for receiving the protrusion.

7. The tray assembly of claim 1, wherein the slider slides in both a first and second opposing directions from an original position.

8. The tray assembly of claim 7, wherein the end wall of the slider pushes a container on the lower tray toward an opposing end wall of the tray.

9. The tray assembly of claim 1, wherein the tray has a lower side having a plurality of container pockets for receiving a top portion of a plurality of containers.

10. A tray assembly comprising:
a tray having a plurality of container support areas; and
a slider having a front end wall connected to a rear end wall, the rear end wall adjacent the plurality of container support areas of the tray and slidable across the plurality of container support areas.

11. The tray assembly of claim 10, wherein the tray includes a first interlocking portion and the slider includes a second interlocking portion to slidably connect the tray to the slider.

12. The tray assembly of claim 11, wherein the tray comprises a widened area of the first interlocking portion for receiving the second interlocking portion.

13. The tray assembly of claim 10, wherein the slider slides in both a first and second opposing directions from an original position.

14. The tray assembly of claim 13, wherein the one of the rear end wall of the slider pushes a container on the lower tray toward an opposing end wall of the tray.

15. The tray assembly of claim 10, wherein the tray includes a blocking device at opposing ends to prevent the slider from separating from the tray.

16. The tray assembly of claim 10, wherein the tray has a lower side having a plurality of container pockets for receiving a top portion of a plurality of containers.

17. The tray assembly of claim 10, wherein a protrusion extends from the slider to interfit with a detent formed between a plurality of protrusions extending from the tray to retain the slider in the original position with the tray.

18. A tray assembly comprising:
a tray having a plurality of container support areas; and
a slider having a pair of end walls slidably mounted to the tray, at least a first one of the end walls slidable across at least a portion of the plurality of container support areas, at least a second one of the end walls including at least one window defined adjacent a raised portion of the second one of the end walls.

19. The tray assembly of claim 18, wherein the tray includes a first interlocking portion and the slider includes a second interlocking portion to slidably connect the tray to the slider.

20. The tray assembly of claim 19, wherein the tray comprises a widened area of the first interlocking portion for receiving the second interlocking portion.

21. The tray assembly of claim 18, wherein the slider slides in both a first and second opposing directions from an original position.

22. The tray assembly of claim 21, wherein the one of the end walls of the slider pushes a container on the lower tray toward an opposing end wall of the tray.

23. The tray assembly of claim 18, wherein the tray includes a blocking device at opposing ends to prevent the slider from separating from the tray.

24. The tray assembly of claim 23, wherein the blocking device is a tab extending upward from the tray to black the end walls of the slider.

25. The tray assembly of claim 18, wherein the tray has a lower side having a plurality of container pockets for receiving a top portion of a plurality of containers.

26. The tray assembly of claim 18, wherein a protrusion extends from the slider to interfit with a detent formed between a plurality of protrusions extending from the tray to retain the slider in an original position with the tray.

27. A tray assembly comprising:
a tray having a plurality of interlocking features located on an underside of the tray and including a plurality of container support areas located on the upperside of the tray; and
a slider having a pair of side walls slidably mounted to the tray, the pair of side walls including complementary interlocking features that are interlockable with interlocking features on an underside of a similar tray assembly.

28. The tray assembly of claim 27 wherein the interlocking features are interlockable with the complementary interlocking features when the tray assembly and the similar tray assembly are oriented in a cross-stacked arrangement.

29. The tray assembly of claim 27 wherein the interlocking features are interlockable with the complementary interlocking features when the tray assembly and the similar tray assembly are oriented in an aligned, stacked arrangement.

30. The tray assembly of claim 27, wherein a protrusion extends from the slider to interfit with a detent formed between a plurality of protrusions extending from the tray to retain the slider in the original position with the tray.

31. A method for arranging a plurality of containers on a tray including the steps of:
a) pulling a slide into contact with at least a first pair of the plurality of containers;
b) via said step a), causing the at least the first pair of the plurality of containers to contact at least a second pair of the plurality of containers;
c) via said step b), moving the at least the first pair and the at least the second pair of the plurality of containers toward an end of the tray; and
d) after said step c), pushing the slide back toward an original position.

32. The method of claim 31, wherein said step c) includes pushing the at least first pair and the at least second pair with an end of the slider toward an opposing end of the tray.

33. The method of claim 31, wherein said step d) includes retaining the slide in the original position with a protrusion extending from the slider interfitting with a detent formed between a plurality of protrusions extending from the tray.
